(19) United States
(12) Patent Application Publication
(10) Pub. No.: US 2015/0128040 A1
(43) Pub. Date: May 7, 2015

(54) GENERATING CUSTOM SEQUENCES OF VIDEO STREAMS

(71) Applicant: D Skyler Nielsen, Salem, UT (US)

(72) Inventor: D Skyler Nielsen, Salem, UT (US)

(21) Appl. No.: 14/533,774

(22) Filed: Nov. 5, 2014

Related U.S. Application Data
(60) Provisional application No. 61/900,278, filed on Nov. 5, 2013.

(51) Int. Cl. G06F 3/0484; G06F 17/30

(52) U.S. Cl. CPC G06F 3/0484; G06F 17/30091
USPC 715/716

(57) ABSTRACT

Custom sequences of video streams are generated and stored. These video streams can be of the same event and can be presented to the user to allow the user to select to view a particular stream at any given time during playback of the event or occurrence. The sequence in which the user selects the streams for viewing the event can be stored in a data structure to enable the custom sequence to be replayed at a later time.

### RELATED APPLICATIONS

This application claims priority to U.S. Provisional Application No. 61/900,278, filed Nov. 5, 2013 and titled GENERATING CUSTOM SEQUENCES OF VIDEO STREAMS, which application is incorporated herein in its entirety.

### BACKGROUND

With the proliferation of mobile devices that include cameras, it has become common to film an event or an occurrence. For example, many spectators may film a concert, a wedding, a sporting event, or other occurrence. The multiple videos that are generated of an event are oftentimes made available for later viewing such as by posting the videos to YouTube.

Some providers have developed websites or other tools for aggregating different videos of a common event together. FIG. 1 illustrates an example of how some websites simultaneously display multiple videos of a common event. As shown, a user interface 100 (e.g. a webpage) can include a main video player 101. A plurality of video streams 102a-102c of the same event can be displayed next to main video player 101. These video streams were generated using different devices at the same time during the event and therefore the streams can be synchronized.

For example, if the event is a concert, each stream may include a song that a band performed during the concert. In such a case, interface 100 can allow the user to select which stream is rendered by main video player at any given time during playback of the song. For example, the user may initially view stream 1 for the first minute of the song (i.e. until time 1:00 with respect to the time at which the band began playing the song). Then, the user may select stream 2. Instead of commencing playback of stream 2 from the beginning of the stream as would be typical in video players such as YouTube, main video player 101 can commence playback of stream 2 at the point that correlates with where stream 1 left off. In other words, the playback of stream 2 can commence at the point in stream 2 that correlates with time 1:00 with respect to the time at which the band began playing the song. In this manner, the user can switch from stream to stream during playback of the song.

### BRIEF SUMMARY

The present invention extends to methods, systems, and computer program products for generating custom sequences of video streams. These video streams can be of the same event and can be presented to the user to allow the user to select to view a particular stream at any given time during playback of the event. The present invention can track the sequence of streams that the user selects for viewing the event and store this sequence in a file or other data structure. In this way, the user's custom sequence can be stored for later viewing or sharing.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example user interface in which multiple streams of the same event can be presented for playback;

FIG. 2 illustrates an exemplary computing environment in which the present invention can be implemented;

FIGS. 3A-3D illustrate how a user can select a custom sequence of video streams during playback of an event; and

FIGS. 4-6 illustrate example data structures that define a custom sequence.

### DETAILED DESCRIPTION

The present invention extends to methods, systems, and computer program products for generating custom sequences of video streams. These video streams can be of the same event and can be presented to the user to allow the user to select to view a particular stream at any given time during playback of the event. The present invention can track the sequence of streams that the user selects for viewing the event and store this sequence in a file or other data structure. In this way, the user's custom sequence can be stored for later viewing or sharing.

### Example Computer Architecture

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

### Example

### Environment in which the Invention May be Implemented

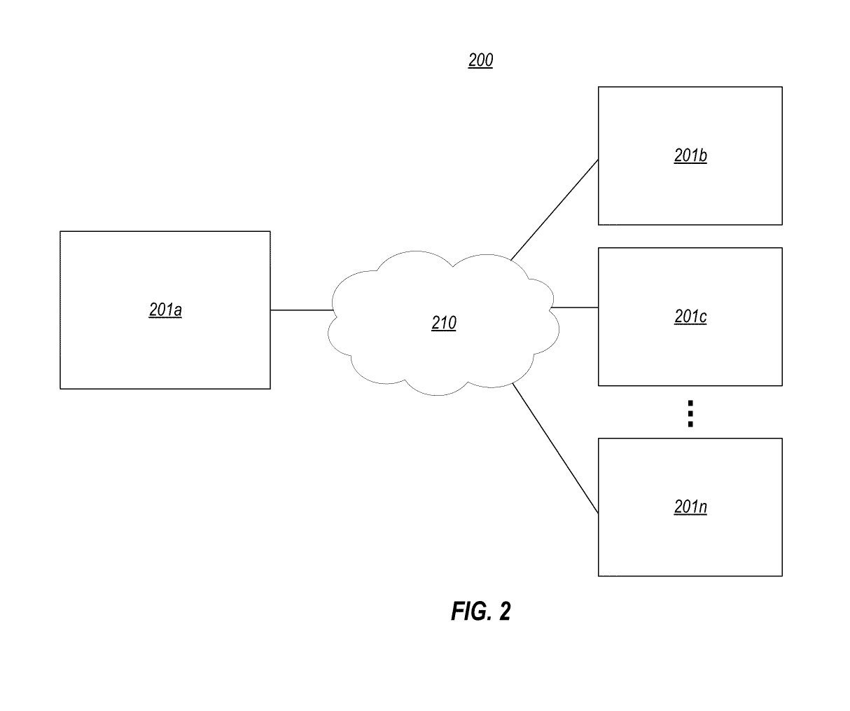

FIG. 2 illustrates an example computer environment 200 in which the present invention can be implemented. Computer environment 200 includes computing devices 201a-201n that are interconnected via a network 210. In this example, computing device 201a represents the device on which multiple video streams can be viewed. Computing device 201a can represent a personal computer, a tablet, a smart phone, or any other computing device capable of rendering video streams. In some cases, the present invention can be implemented on a single computing device such as computing device 201a. Network 210 can generally represent the internet, but can also encompass any other type of connection between computing devices including direct connections such as Bluetooth or NFC.

Computing devices 201b-201n can represent one or more computing devices from which one or more video streams are received, or one or more computing devices with which a custom sequence is shared. For example, computing device 201b can represent a server from which computing device 201a obtains video streams whether the streams are live (e.g. when computing device 201b is generating the stream using a camera of the device or is receiving a live stream from another computing device) or stored (e.g. a server that accumulates video streams such as a YouTube server). Alternatively, computing device 201c can represent a device on which another user views a custom sequence created by a user of computing device 201a.

In short, the present invention can typically be implemented in an internet based environment where any device can access video streams regardless of where the streams originate and generate custom sequences which may then be shared with any other device. Accordingly, the particular environment in which the invention is implemented is not essential.

Generating Custom Sequences of Video Streams

In accordance with embodiments of the present invention, while a user is viewing an event or occurrence (hereinafter event) having multiple video streams and as the user switches between viewing the different video streams, a custom sequence can be generated. The custom sequence therefore defines which video stream the user was watching at any given time during playback of the event. The custom sequence can be stored in a data structure that can be shared with other users to enable the other users to watch the event following the same custom sequence.

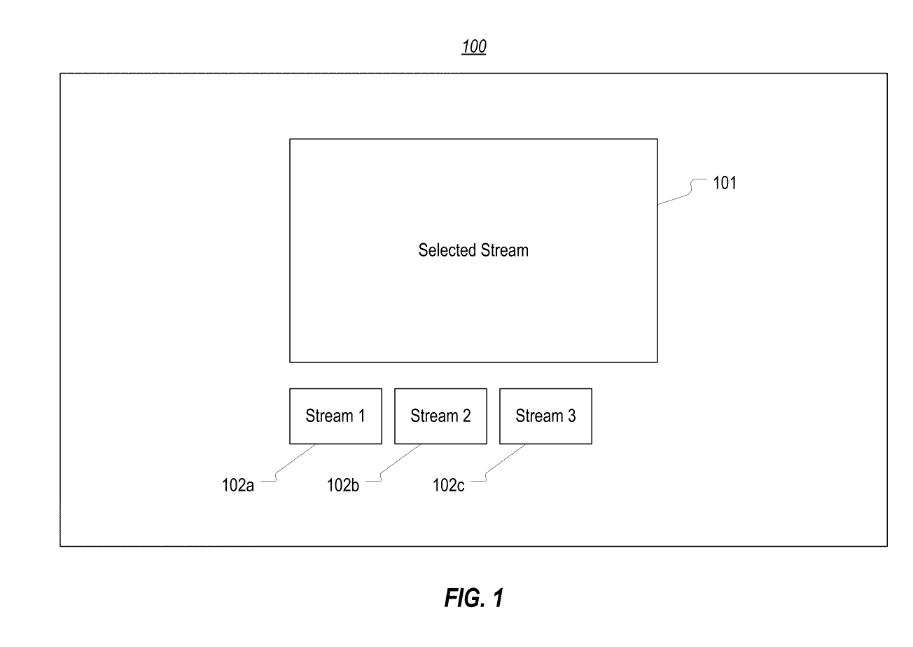

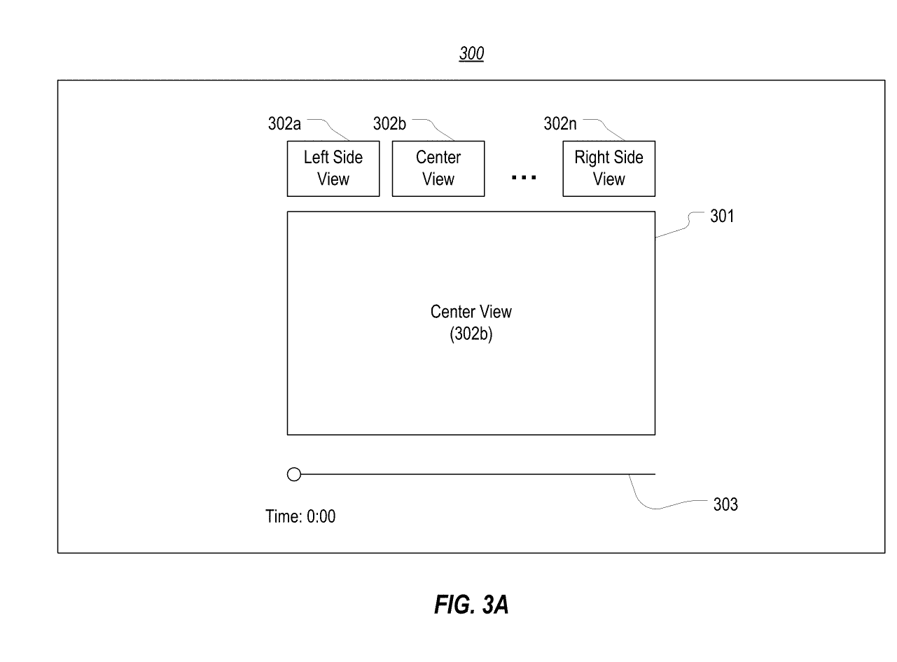

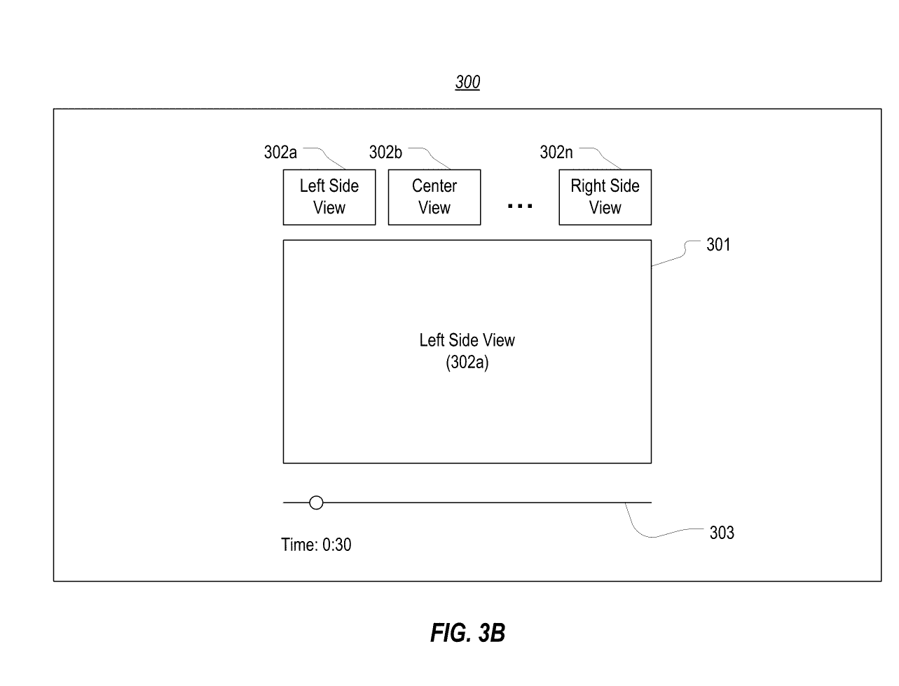

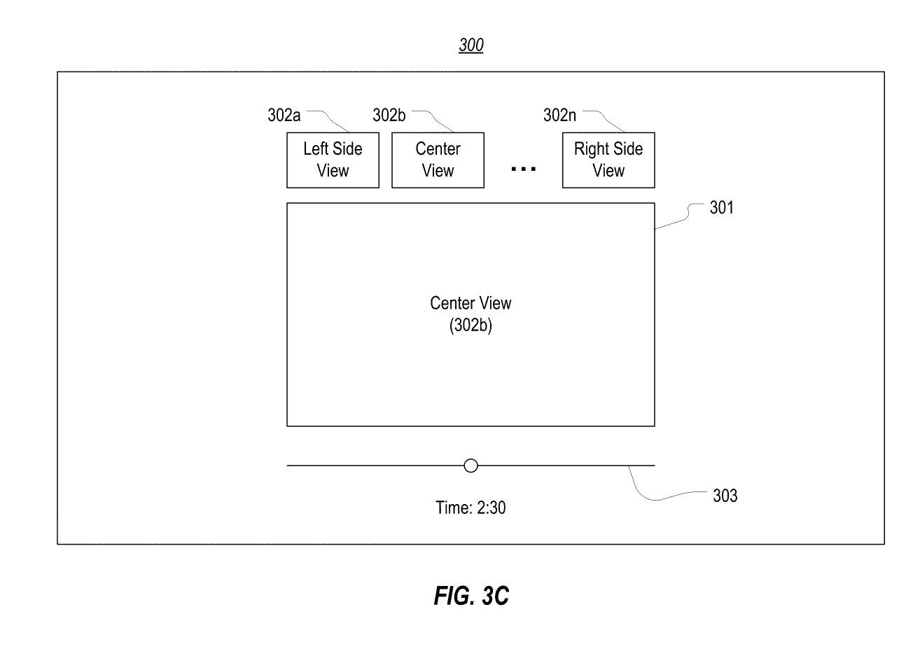

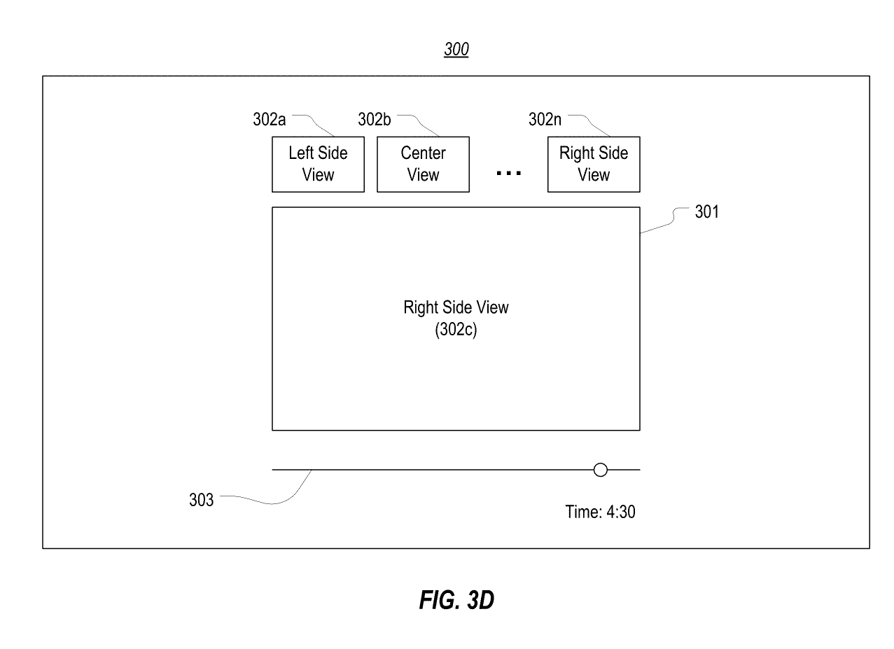

FIGS. 3A-3D illustrate an example of how a custom sequence can be generated. These figures are similar to FIG. 1 in that the depicted interface 300 includes a main video player 301 and a plurality of video streams 302a-302n. Each of the streams encompasses the same event (i.e. the devices used to generate each stream were filming the event at the same time) with the streams comprising a left side view, a center view, and a right side view respectively. A playback position indicator 303 defines the current playback position of the event. The playback position of the event can generally be thought of as the time during the actual event. For example, if the event is a concert that was twenty minutes long, the playback position of the event would represent the time within the twenty minutes of the concert. The mapping of the current playback position of the event to the playback position of each video stream encompassing the event can be determined via synchronization of the video streams.

To enable the switching between streams during playback of the event, a computer system (whether the computing device on which user interface 300 is displayed or another computer system such as a server) can synchronize each stream. Synchronizing implies that the computer system knows which portion of each stream depicts the same time of the event.

The specific manner in which the computer system synchronizes the streams is not essential to the invention. However, for the sake of clarity the following examples are given. In one example, the computer system can maintain a listing of offsets into each video stream. The offset for a particular stream can define a time from the beginning of the stream at which an event commences. For example, if the event is the playing of a song at a concert, the offset can define a time from the beginning of the stream when the band starts playing the song. If the song was filmed using three different devices and therefore three different streams exist, the computer system may maintain three offsets defining when the song starts within each stream.

As an example, the song may start at time 0:05 of the first stream, at time 0:30 of the second stream, and at time 4:52 of the third stream. In this case, the offsets would be 0:05, 0:30, and 4:52 for each stream respectively. Of course, relative offsets (i.e. offsets into other streams with respect to the start of an event in one stream) could also be used. Synchronizing using offsets can be beneficial when the streams are of different lengths and/or encompass more than the event to be played back.

As another example, synchronizing could be performed by modifying the streams so that they only encompass the event to be played back (e.g. so that they are of the same length with the start of the event being at the beginning of each stream). In this case, no offsets would be required because the same time within each stream represents the same time of the event (e.g. the start of the song would be at time 0:00 in each stream). Synchronizing in this manner simplifies playback (because there is no need to calculate offsets), but may require preprocessing of the video streams to remove portions of the stream that do not encompass the event.

As a further example, when the streams are live streams, synchronizing can be performed using timestamps contained in the live streams. The computer system can use the timestamps to synchronize the different streams to ensure that they align.

In any of the above techniques for synchronizing, the synchronization can occur prior to playback or during playback. Synchronization performed prior to playback implies that the computer system performs the necessary synchronization prior to playback so that switching between streams can occur without the need to calculate where to jump into the switched-to stream. Such may be the case when each video stream is concurrently rendered. Because each stream may be concurrently rendered in synchronization, the computer system will need only switch over to displaying the switched-to stream in the main video player. In some embodiments, multiple streams may be composited into a single stream (e.g., with each of the multiple streams occupying a particular corner of the composited stream). In such cases, the streams can be composited in synchronization so that switching from one stream to another can be accomplished by cropping the composite stream to include only the selected stream.

Synchronization performed during playback implies that the computer system calculates where to jump into a stream when the stream is selected for playback (e.g. by using the offset of the currently playing stream, the selected stream, and the current position within the playing stream). Such may be the case when the streams are not concurrently rendered (i.e. only the stream that is currently selected for viewing is played back).

Regardless of how synchronization is performed, the present invention can record data defining each time that the user selects to view a different stream during playback of an event. This data therefore defines an interleaved sequence of portions of the video streams which can then be stored or shared to allow the same sequence to be viewed again.

Returning to FIG. 3A, as depicted by playback position indicator 303 being at the left (i.e. time 0:00), the user has just begun watching the event. The user has selected to view center view stream 302b (or alternatively, center view stream 302b is the default stream). Accordingly, the computing device can record that the user has selected to view center stream 302b at time 0:00. Next, as shown in FIG. 3B, the user has watched center view stream 302b until time 0:30 at which point the user selects to view left side view 302a. Accordingly, the computing device can record that the user has switched to watch left side view 302a at time 0:30. Then, as shown in FIGS. 3C and 3D, the user switches to watch center view stream 302b at time 2:30 and right side view 302c at time 4:30. Although not shown, it is assumed the user continues watching right side view 302c until the end of the event. The computing device can record these switches between streams.

Various user input options can be provided to allow the user to switch between different streams. For example, selectable representations of each stream can be displayed within a user interface to allow the user to select each stream via mouse input, cursor input (e.g., via left and right or up and down arrow keys), touch input (when a touch display is employed), or keyboard input (e.g., via assigned keys for each stream such as 1, 2, 3, and 4 for each of four streams).

After the playback of the event has completed, the data stored for defining the sequence of playback can be represented as:
Time 0:00—Center View Stream 302b
Time 0:30—Left Side View Stream 302a
Time 2:30—Center View Stream 302b
Time 4:30—Right Side View Stream 302c

The actual data stored for defining the sequence can depend on various factors such as how synchronization is performed among the streams. In any case, the data defines sufficient information to allow the sequence of streams to be replayed when the event is again watched.

For example, after watching the event, the user can select to share the sequence with a friend. The data defining the sequence can then be sent to the friend's computing device to enable the computing device to playback the event following the same sequence. In this way, the friend is able to experience the event in the same manner as the user that created the sequence. A sequence can be shared in virtually any way such as by posting the sequence to a social media website, sending an email or text, or otherwise providing access to the sequence to enable a computing device to playback each portion of the streams in the proper sequence.

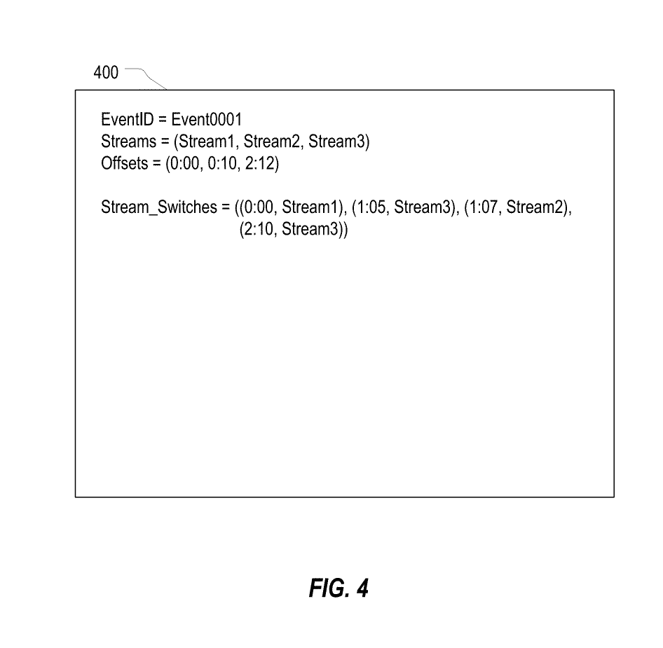

FIG. 4A illustrates a simplified example of a data structure 400 that stores data defining a sequence. Data structure 400 can represent the case when offsets are used to synchronize the streams. As shown, data structure 400 includes an EventID which identifies the event to which the sequence pertains, a Streams array which includes identifiers of each stream in the event, an Offsets array that defines an offset to the beginning of the event in each stream, and a Stream_Switches array that defines each switch between streams that occurs during playback of the event. Of course, the Streams and Offsets array need not be directly included in the data structure but could be accessed from another data structure using the EventID or other identifier.

In this example, playback commences with Stream1 and transitions to Stream3 at time 1:05, to Stream2 at time 1:07, and to Stream3 at time 2:10. Data structure 400 therefore defines sufficient information for the event to be subsequently played back in accordance with the defined sequence.

To playback the sequence defined in data structure 400, a computing device can process the Stream_Switches array to identify when to transition to each stream during playback of the event. The Offsets array can be processed to determine where within each stream playback should occur. For example, at time 0:00 of playback of the event, Stream1 will commence playing at position 0:00 (because the offset of Stream1 is 0:00). Then, at time 1:05 of playback of the event, a transition will be made to commence playing Stream3 at position 3:17 of Stream3 (time 1:05 of playback+the 2:12 offset). At time 1:07 of playback, a transition will be made to commence playing Stream2 at position 1:17 of Stream2 (time 1:07+the 0:10 offset). Finally, at time 2:10 of playback, a transition will be made to commence playing Stream3 at position 4:22 of Stream3 (time 2:10+the 2:12 offset). Stream3 will continue playing until the event has completed playback (which may be the end of Stream3 or may otherwise be determined using the length of the event and the offset of Stream3).

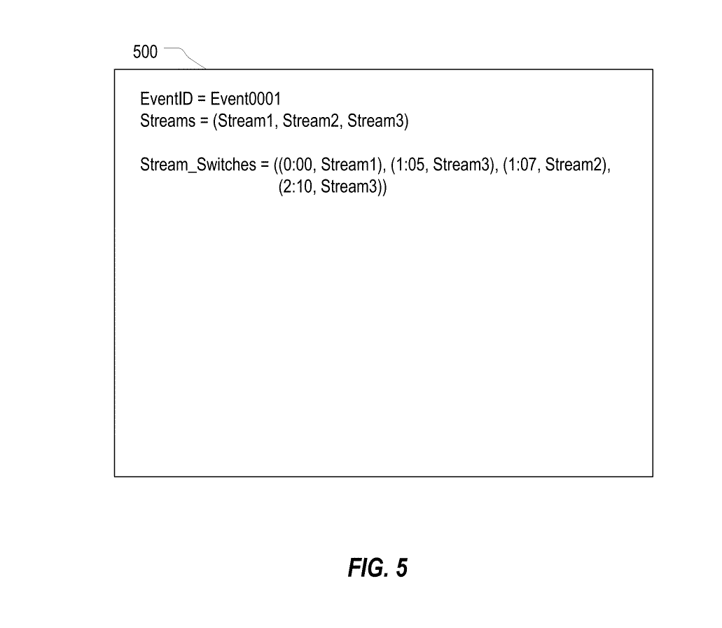

FIG. 5 also illustrates a simplified example of a data structure 500 that stores data defining the same sequence as shown in FIG. 4. Data structure 500, however, can represent the case when no offsets are used. Because the start of each stream corresponds with the start of the event (or alternatively, because the start of the event occurs at the same time within each stream), the playback of the sequence can be accomplished using the time of the transition to each stream (as defined in Stream_Switches).

Data structures 400 and 500 represent the types of data structures that can be stored, transmitted, or otherwise made available to allow other users to experience the same sequence generated by a user. In this manner, any number of custom sequences can be generated and shared.

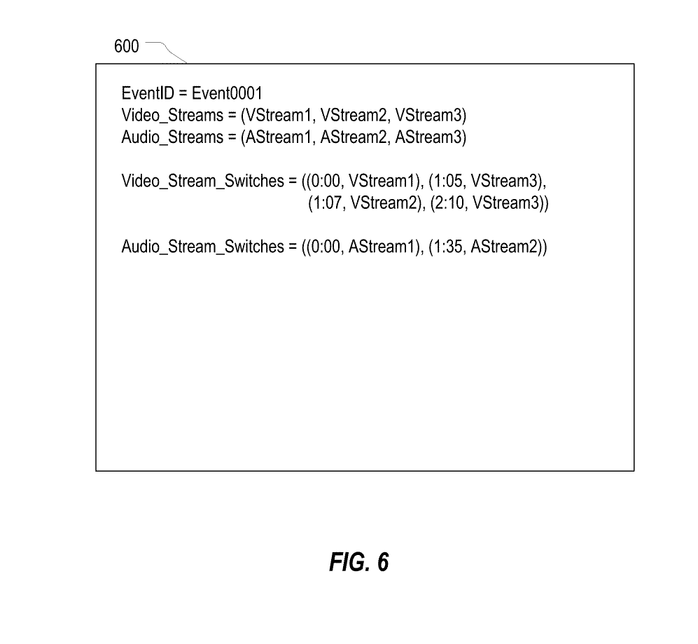

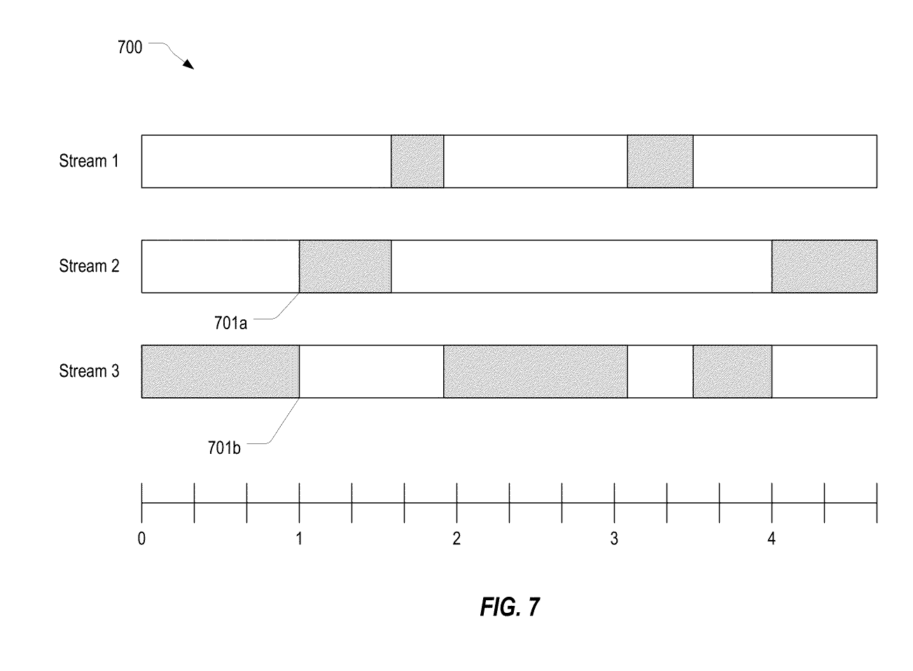

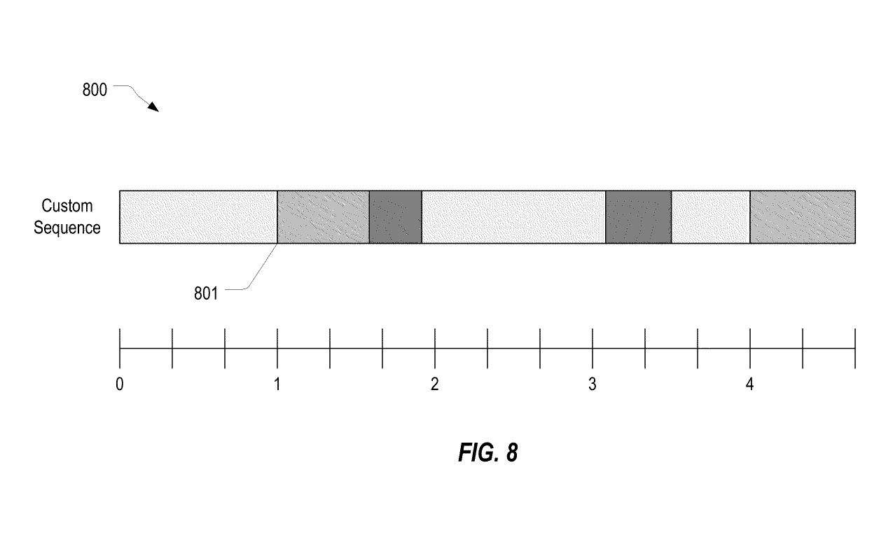

The present invention can also provide flexibility in controlling which audio stream is output during playback of the event. For example, in some embodiments, the audio of the currently selected stream can be output. Alternatively, the user can be given the option to switch between audio streams in a similar manner as can be done with the video streams. In such cases, the data structure storing the sequence can also define a sequence of audio streams that the user selected during playback. FIG. 6 illustrates an example data structure 600 defining a sequence of video and audio stream transitions during playback of an event. As shown, the video stream transitions are the same as in data structure 500. Additionally, an Audio_Stream_Switches array defines that AStream1 was initially played until time 1:35 when AStream2 was selected for output. As can be seen, the transitions between audio streams do not need to coincide with the transitions between video streams. Also, even though the same number of audio and video streams are shown, a sequence can also be defined when there are different numbers of audio and video streams (e.g. when one device captured only video or only audio). Further, in some embodiments, an audio stream may not be associated with the event. For example, the audio stream may be an unrelated song that the user desires to associate with the sequence.

In some embodiments, the present invention can also allow multiple audio streams to be output simultaneously during playback. In such cases, the definition of a sequence can be performed as described above except that a transition may define more than one audio stream. For example, Audio_Stream_Switches in data structure 600 may include the transition (1:35, AStream2, AStream3) representing that at time 1:35 of playback, the user selected to output AStream2 and AStream3.

Although the present invention has been described as allowing the creation of custom sequences of video streams of the same event, the same techniques can be used to generate custom sequences of videos of any type whether or not they are of the same event. For example, software tools exist for combining multiple video files or clips together into a single video file. However, these tools are difficult to use and require a substantial amount of training. In contrast, the present invention can allow a user to create custom sequences of video streams for playback by simply selecting to watch a particular stream at a particular time.

For example, referring to FIG. 3A, video streams 302a, 302b, and 302n (which are assumed to encompass unrelated events or content) can all be simultaneously rendered with only a single selected stream being displayed within main video player 301. As described above, the user can select which of the video streams will be displayed in main video player 301 at any given time. These selections can be recorded as described above to allow the same sequence to be replayed at a later time. In other words, the recorded sequence will define which video stream should be rendered within main video player 301 at each instance of a duration of time.

In some embodiments, the present invention can provide various transition options that can be applied when transitioning between streams. These transitions can include fading, dissolving, or sliding the currently playing stream when transitioning to a subsequent stream and transitioning to the subsequent stream using a page turn transition. A user may be given the option to specify which transition to apply between each selected stream.

Once users have created a custom sequence, the present invention can display a timeline that shows the transitions between each stream. For example, FIG. 7 illustrates a timeline 700 that can be displayed when a user has created a custom sequence from three streams. The layout of timeline 700 is merely exemplary and other layouts could equally be used. Timeline 700 shows each of the three streams along a four and a half minute timeline. The gray shading in each stream represents when each stream was selected. Accordingly, at time 1:00, the user selected to transition from stream 3 to stream 2. This transition is represented by edge 701a in stream 2 as well as edge 701b in stream 3.

Timeline 700 can be configured to allow the user to adjust the timing of any of the transitions. This can allow the user to modify the custom sequence without having to recreate the custom sequence. For example, by selecting either edge 701a or edge 701b, the user can adjust the timing of the transition from stream 3 to stream 2 at time 1:00. For example, if the user clicked on edge 701a and dragged it to the left, edge 701b could also be moved to the left in unison with edge 701a. In this way, the user can easily adjust when the transition from stream 3 to stream 2 occurs such as by moving the transition to 0:55 rather than 1:00.

FIG. 8 illustrates another example timeline 800 that can be displayed to allow the user to customize when transitions between selected streams occur. Timeline 800 depicts the same custom sequence as timeline 700. However, timeline 800 displays the transitions in a single series with the transitions between each stream being distinguished using a different color (light gray for stream 3, medium gray for stream 2, and dark gray for stream 1). The use of different colors is for illustration purposes and any other suitable means for distinguishing between streams or identifying transitions between streams could be used. In some cases, the angle of the camera can be sufficient to distinguish between streams and therefore thumbnails of the selected stream could be displayed to represent the selected sequence. To adjust the timing of a transition using timeline 800, the user can select the edge between the segments and drag it to the left or right. For example, the user could select edge 801 at time 1:00 and drag it to the left to cause the transition from stream 3 to stream 2 to occur at an earlier time (e.g., at 0:55).

Although not shown, when the custom sequence includes audio streams, the timeline can represent the transitions between audio streams and provide the user with the ability to adjust the timing of the transitions. By displaying a timeline of a custom sequence, the present invention can allow the user to modify the custom sequence without having to re-watch the streams to recreate a custom sequence with the desired transitions. The timeline therefore facilitates fine tuning a custom sequence or correcting errors in a custom sequence. Once a user has interacted with a timeline representing the custom sequence including adjusting the timing of the transitions between selected streams, the corresponding data structure can be updated to include the adjusted times for the transitions. For example, data structure 600 could be updated so that the Video_Stream_Switches and/or the Audio_Stream_Switches array includes the updated transition values.

As stated above, in some cases, the source of a stream can be a live event. In such cases, multiple cameras that are capturing the event can generate live streams that can be encoded and transmitted to a server (e.g., computing device 201a) in real-time. To facilitate synchronizing the live streams, the encoding process can include timestamps within the streams. These live streams can then be made available in any of the ways described above to create custom sequences.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, performed by one or more processors of a computer system, for generating a data structure that defines a custom sequence in which a plurality of video streams of an event were played back, the method comprising:
presenting a plurality of video streams to a user on a display, wherein each of the plurality of video streams captured the same event;
receiving user input that selects a first video stream of the plurality of video streams for playback;
commencing playback of the first video stream at a position in the first video stream that corresponds to a first time during the event;
storing, in a data structure for defining a custom sequence, a first indication that the first video stream was selected and associating the first indication with the first time;
receiving, while the playback of the first video stream is at a position that corresponds to a second time during the event, user input that selects a second video stream of the plurality of video streams for playback;
commencing playback of the second video stream at a position in the second video stream that corresponds to the second time; and
storing, in the data structure, a second indication that the second video stream was selected and associating the second indication with the second time.

2. The method of claim 1, further comprising:
providing access to the data structure to a second user.

3. The method of claim 2, wherein providing access comprises one or more of:
publishing a representation of the custom sequence to enable the second user to select to replay the custom sequence;
transmitting the data structure to another computer system to enable the other computer system to replay the custom sequence; or
storing the data structure on the computer system to enable the computer system to replay the custom sequence.

4. The method of claim 1, wherein the first time comprises the start of the event.

5. The method of claim 1, wherein each of the plurality of video streams captured the event at a different angle.

6. The method of claim 1, wherein one or more of the plurality of video streams includes an audio stream.

7. The method of claim 6, further comprising:
receiving, while the playback of the first video stream is at a position that corresponds to a third time during the event, user input that selects an audio stream for playback;
commencing playback of the audio stream at a position in the audio stream that corresponds to the third time; and
storing, in the data structure, a third indication that the audio stream was selected and associating the third indication with the third time.

8. The method of claim 7, wherein the audio stream is associated with a video stream other than the first video stream.

9. The method of claim 7, wherein the audio stream is not associated with any of the plurality of video streams.

10. The method of claim 7, wherein the audio stream does not include audio captured during the event.

11. The method of claim 1, wherein the position in the second video stream that corresponds to the second time is calculated using an offset.

12. The method of claim 11, wherein the position in the second video stream that corresponds to the second time is calculated using the offset prior to playback of the second video stream.

13. The method of claim 1, wherein at least one of the plurality of video streams is a live stream.

14. A method, performed by one or more processors of a computer system, for generating a data structure that defines a custom sequence in which a plurality of video streams of an event were played back, the method comprising:
commencing playback of a plurality of video streams on a display;
receiving user input that selects a first video stream of the plurality of video streams at a first time;
storing, in a data structure for defining a custom sequence, a first indication that the first video stream was selected and associating the first indication with the first time;
receiving user input that selects a second video stream of the plurality of video streams at a second time;
storing, in the data structure, a second indication that the second video stream was selected and associating the second indication with the second time such that the data structure defines a custom sequence of the first video stream being selected between the first and second time and the second video stream being selected after the second time.

15. The method of claim 14, further comprising:
commencing playback of the custom sequence including:
playing the portion of the first video stream that was rendered between the first and second times; and
after playing the portion of the first video stream, playing the portion of the second video stream that was rendered after the second time.

16. The method of claim 15, further comprising:
playing audio content while the portions of the first and second video streams are played.

17. The method of claim 14, wherein the first and second video streams are of different events.

18. The method of claim 14, wherein the first and second video streams are of the same event.

19. The method of claim 18, wherein the first and second video streams are synchronized.

20. The method of claim 19, wherein the first and second video streams are live streams.
